(19) United States
(12) Patent Application Publication
(10) Pub. No.: US 2019/0380905 A1
(43) Pub. Date: Dec. 19, 2019

(54) FITNESS, BEAUTY OR WELLNESS DEVICE

(71) Applicant: Airpressure Bodyforming GmbH, Berchtesgaden (DE)

(72) Inventors: Oliver Sekula, Berchtesgaden (DE); Hubert Greinwalder, München (DE); Gert Rechenmacher, Kapfenburg (AT)

(21) Appl. No.: 16/486,358

(22) PCT Filed: Feb. 16, 2018
(86) PCT No.: PCT/EP2018/053890

§ 371 Date: Aug. 15, 2019

(30) Foreign Application Priority Data
Feb. 16, 2017 (EP) PCT/EP2017/053545
Apr. 6, 2017 (EP) PCT/EP2017/058236

(51) Int. Cl. A61H 9/00

(52) U.S. Cl. CPC A61H 9/0078; A61H 2201/1238; A61H 2205/108; A61H 2201/165

(57) ABSTRACT

A fitness, beauty or wellness device comprises:

a functional unit (11) wearable on a user's body having a first fastening means (13) forming at least a first support point (A) on the functional unit (11) and a first connecting means (30) forming at least a second support point (B) on the functional unit (11), and

a pump (20) comprising a second fastening means (21) for releasably coupling to the first fastening means (13) and a second connecting means (50) for fluid-tightly coupling to the first connecting means (30);

wherein the pump (20) is retained on the functional unit (11) by coupling the first fastening means (13) to the second fastening means (21) at the first support point (A) and additionally by coupling the first connecting means (30) to the second connecting means (50) at the second support point (B),

wherein at the first support point (A) the pump (20) is retained at an angle (α) to the functional unit (11), and

wherein for coupling the first connecting means (30) and the second connecting means (50) at the second support point (B), the pump (20) is tilted in the direction of the functional unit (11) by reducing the existing angle (α) between the pump (20) and the functional unit (11).

The invention relates to a fitness, beauty or wellness device equipped with a functional unit which can be worn on a user's body, and with a pump which can be connected to said device. The invention also relates to a functional unit and a pump used for such a fitness, beauty or wellness device. In addition, the invention relates to a method of attaching the pump to the functional unit.

Due to the ever increasing technological advancement of our lives, modern technology has found its way into fitness, beauty and wellness, too. Common applications and methods for the care and shaping of one's own body can be further improved through the use of new technologies. The focus is often on the so-called problem zones, especially thighs and abdomen. This is why garments, cuffs and belts have been designed to develop their effects especially in the problem zones, caused by stimulation current, heat or massages.

EP 1 248 586 B1, for instance, discloses a fitness device that creates a massage effect in problem zones by means of negative pressure. Other such fitness machines are known from EP 1 307 168 B1 and WO 03/030808 A1.

Furthermore, US 2002/062515 A1 describes a pair of trousers that have a massage function. The trousers consist of a front fabric and a back fabric, which are wrapped around the wearer's body and fixed together with buckles. The trousers have air pockets connected to a pump by connecting tubes. The pump applies air to the air pockets in such a way that they expand simultaneously. Additionally, vibrators are provided on the trousers to achieve the massage function.

A fitness device in the form of trousers is also revealed in WO 2014/117986 A2. The fitness device comprises at least one pressure chamber adapted to be pressurised with a fluid and adapted to engage a body part of a person, a pump means connected to the pressure chamber and adapted to pressurise the pressure chamber with the fluid, and a control means for controlling the pump means. The pump is held in place by a separate support strap.

US 2012/089059 A1 discloses a system to increase blood flow in blood vessels. The system comprises a garment for pneumatic distribution of fluid. The garment is used in particular for the leg and foot region, but can also be used for the thighs, arm, hand or shoulder. The garment includes sheets of flexible plastic such as PVC. The garment can be fastened to the respective body region with the aid of fasteners. The garment also includes a pneumatic network of pneumatic cells that can exert pressure on the body. In addition, the system includes a control device located on the garment.

EP 2 168 553 A1 discloses a compression device. The compression device is placed around the leg of a wearer and comprises three inflatable elements. A control device or air compression unit is attached to the compression device. A connecting device for connecting the control device to the compression device comprises female connecting elements for receiving male connecting elements of the control device. The connecting elements each have a bulbous design which can be clipped together for connection.

There is a need for improvement in the well-known fitness, beauty or wellness devices regarding the sometimes unsatisfactory handling, which often makes personal assistance in a beauty salon, a fitness studio or a wellness centre necessary in order to ensure a functional application, and thus limits the range of application.

It is the task of this invention to improve a fitness, beauty or wellness device with regard to handling and range of application.

The task is solved by a fitness, beauty or wellness device according to claim 1, a pump according to claim 18, a functional unit according to claim 19 and a method according to claim 20. Preferred embodiments of the fitness, beauty or wellness device according to the invention are reflected in claims 2 to 17.

The fitness, beauty or wellness device according to the invention comprises a functional unit which can be worn on a user's body and which has a first attachment means forming at least one upper support point on the functional unit and a first connecting means forming at least one second support point on the functional unit. The device further comprises a pump having second attachment means for releasably connecting to the first attachment means and second connecting means for fluid-tightly coupling to the first connecting means. Additionally, the pump is retained on the functional unit by coupling the first attachment means to the second attachment means at the first support point and by coupling the first connecting means to the second connecting means at the second support point.

The multiple support of the pump at the first and second support points ensures a secure attachment of the pump to the functional unit, which is, for example, a pair of trousers similar to those described in WO 2014/117986 A2, with a high degree of freedom of movement for the user. The functional unit may also be a belt or cuff as described in EP 2 020 979 B1. The support of the pump at at least one first support point as well as at least one second support point takes into account a simple and practical handling. The functional integration of the first connecting means and the second connecting means into the support of the pump on the functional unit ensures a simple and cost-effective design.

When connecting the pump to the functional unit, it is advantageous to first connect, in particular to hook in, the second fastening means, e.g. a fastening hook, to the first fastening means, e.g. a fastening loop, at an angle at the first, suitably upper, support point. By tilting the pump in the direction of the functional unit, the first connecting means is connected to the second connecting means at the second, suitably lower, support point. By tilting, the initial angle between the pump and the functional unit is reduced, and the first connecting means is fluid-tightly connected to the second connecting means.

Preferably, the functional unit has a plurality of fluid conduits that are in contact with the user's body during use. The fluid conduits can be supplied with alternating pressure by the pump. This alternating pressure, an overpressure, can assist the user of the functional unit in shaping his/her body and taking care of his/her skin, especially in the problem zones.

Advantageously, the functional unit has a reinforcing support plate, the second support point preferably being formed at the support plate. If the material of the functional unit is not sturdy enough to support the first connecting means, the functional unit may have an reinforcing support plate to provide the required stability.

Advantageously, the first support point comprises at least one upper support point and the second support point comprises at least one lower support point which is located vertically below the upper support point.

Advantageously, the first support point comprises at least one lower support point and the second support point comprises at least one upper support point which is located vertically above the lower support point.

Depending on the area of application and with regard to the wearing comfort of the functional unit and the stability of the pump on the functional unit, it may be useful to place the first support point, formed by the first fastening means, vertically above the second support point, formed by the first connecting means, or vice versa.

The upper support point on the functional unit is usually located outside the region of the support plate. However, depending on the application, e.g. depending on the material and properties of the functional unit, the upper support point may also be located within the region of the support plate. The support plate can be integrallly formed or made of several pieces, which may also be spaced apart. The latter is suitable, for example, if the upper support point is also located in the area of the support plate and the properties of the functional unit necessitate reinforcement of the upper support point.

The first support point and the second support point are arranged at a distance from each other in the horizontal direction in order to further improve the stability or the support of the pump on the functional unit.

Alternatively or additionally, the first support point and the second support point can be arranged vertically at a distance from each other.

Depending on the application, an arrangement of the first support point and the second support point that is offset horizontally and/or vertically with respect to each other may be useful with regard to the wearing comfort of the functional unit and the stability of the pump on the functional unit.

Advantageously, the pump has a housing which is preferably made of plastic.

The first support point and the second support point ensure a secure support of the pump on the functional unit. In order to further improve the pump's support on the functional unit, several first support points and/or several second support points may also be provided. The more support points there are between the pump and the functional unit, the more secure the support of the pump on the functional unit is.

However, the functional unit is preferably designed as a garment, especially as trousers. The more support points are provided between the pump and the functional unit, the lower the flexibility of the functional unit is in this area, which impairs the wearing comfort of the functional unit on the body. Therefore, in a particularly preferred design a single first support point on the functional unit and two second support points on the support plate are provided. Such a three-point support allows a particularly stable support of the pump, in particular a tilt-stable support, on the functional unit to be achieved with comparatively little impairment of the flexibility of the functional unit.

Advantageously, the first fastening means has a fastening loop and the second fastening means has a fastening hook preferably arranged at the housing, wherein the fastening hook can be detachably fastened at to the fastening loop. The combination of fastening loop and fastening hook provides a high fastening potential with simple operation and is characterised by simple and inexpensive production.

Advantageously, the first fastening means or the second fastening means alternatively or additionally comprises a magnet, a clip or a Velcro fastener. The design of the first fastening means and the fastening means may comprise common types of fastening selected depending on the design of the pump and on product factors such as price, complexity, safety and/or wearing comfort.

Advantageously, the first fastening means is designed as a pocket and the second fastening means is formed by the housing.

Advantageously, the first connecting means has at least one connecting dome and the second connecting means has at least one connecting nozzle, the connecting dome being detachably connected to the connecting nozzle. It is expedient to dimension the connecting nozzle in such a way that it can easily be inserted into the connecting dome.

It is advantageous that the second connecting means has at least one recess. The connecting nozzle is arranged in the recess.

Advantageously, the connecting dome has an outer support surface and the recess has an inner support surface, wherein the outer support surface is supported on the inner support surface when the connecting dome is arranged in the recess. Preferably, both the outer support surface and the inner support surface are conical. When the connecting dome is connected to the connecting nozzle, the connecting dome is also arranged in the recess and the outer support surface is supported on the inner support surface. This ensures a particularly stable support of the pump on the functional unit, especially when the user is moving. The conical design of the outer support surface and the inner support surface further improves the stable support.

Advantageously, the connecting dome has a dome connection passage having a depth, wherein the connecting nozzle has a length smaller than the depth of the dome connection passage to form a fluid conduit connection portion. It is therefore expedient that when the connecting nozzle is inserted to its maximum extent into the dome connection passage, the connecting nozzle does not extend over the entire depth of the dome connection passage.

Advantageously, the connecting dome has a dome diameter and the connecting nozzle has a nozzle diameter, the dome diameter preferably corresponding approximately to the nozzle diameter in order to create a force-fit connection between the connecting dome and the connecting nozzle.

Advantageously, the dome connection passage has an inner circumferential surface which forms a pump connection region. Preferably, the inner circumferential surface along the pump connection region is provided with an inner lining. It is advisable to use an elastically deformable material, in particular silicone, for the inner lining in order to ensure simple insertion of the connecting dome into the connecting nozzle as well as reliable sealing in the pump connection region. It is advisable to connect the connecting nozzle with the connecting dome in the pump connection region in such a manner that the inner lining is compressed when the connecting nozzle is inserted into the dome connecting passage.

Preferably, the connecting nozzle in the fluid conduit connection region is connected to a fluid conduit of the functional unit by means of a fluid opening of the dome connection passage. The fluid conduit is connected to the connecting dome by means of a fluid conduit connection. Preferably in the region of the fluid opening of the dome connection passage, the inner support surface in the direction of the fluid conduit connection is shortened and supported at a support edge at the fluid conduit connection. Since the connection nozzle does not extend up to the pump connection region even at maximum insertion depth into the dome connection passage, the fluid opening is not covered by the connecting nozzle and thus does not block the fluid flow from the pump to the functional unit.

Advantageously, the support plate consists of a deformable material that is preferably elastic. The support plate is designed to provide sufficient rigidity for securely fastening the pump to the functional unit without compromising the flexibility of the functional unit. Preferably, the material of which the support plate is made is more rigid than the material of which the functional unit is made in the region where the support plate is located. Preferably, the support plate is of such a deformable material that the support plate substantially adapts to the shape of the user's body part, such as the hip or thigh, which the support plate rests against. It is advisable that the material of which the support plate is made is also rigid enough to ensure a secure connection of the first connecting means to the second connecting means and, if necessary, of the first fastening means to the second fastening means.

Advantageously, the functional unit has a receptacle into which the support plate is inserted, especially sewn in. This ensures a reliable support of the support plate on the functional unit. It is advisable that the support plate is made of a material which has a higher stiffness than the material of which the receptacle is made. It is advisable that the receptacle is made of a material which has a higher stiffness than the material of which the functional unit is made in order to further increase the support of the support plate in the receptacle. Preferably, a dart corresponding to the shape of the support plate is placed in the receptacle in order to fix the support plate inside the receptacle.

The pump for a fitness, beauty or wellness device is characterised by the connection of the first fastening means with the second fastening means at the first support point and, additionally, the connection of the first connecting means with the second connecting means at the second support point.

The functional unit for a fitness, beauty or wellness device is characterised by multiple support of the pump on the functional unit as a result of the connection of the first fastening means with the second fastening means at the first support point and, additionally, the connection of the first connecting means with the second connecting means at the second support point.

The method for fastening the pump to the functional unit for a fitness, beauty or wellness device comprises the following steps:
coupling of the first fastening means with the second fastening means at the first support point at an angle;
tilting the pump in the direction of the functional unit for coupling the first connecting means and the second connecting means at the second support point.

In the following, the invention is described in more detail using an exemplary embodiment, which is illustrated schematically in the drawings. Shown are:

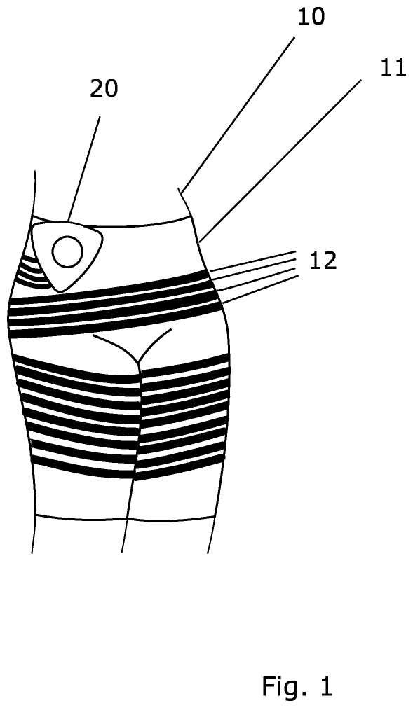

FIG. 1a fitness, beauty or wellness device with a functional unit in the form of trousers;

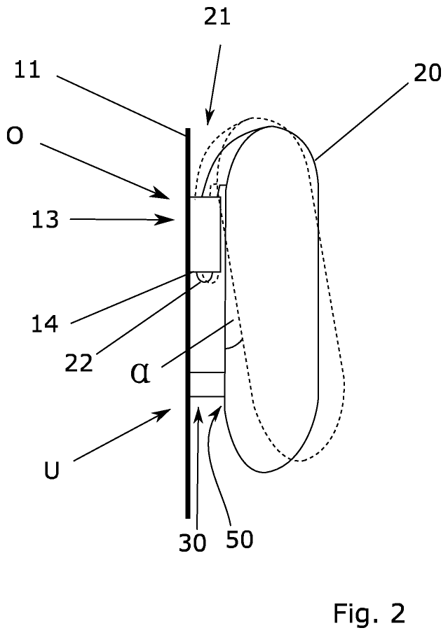

FIG. 2 fastening of a pump to the functional unit;

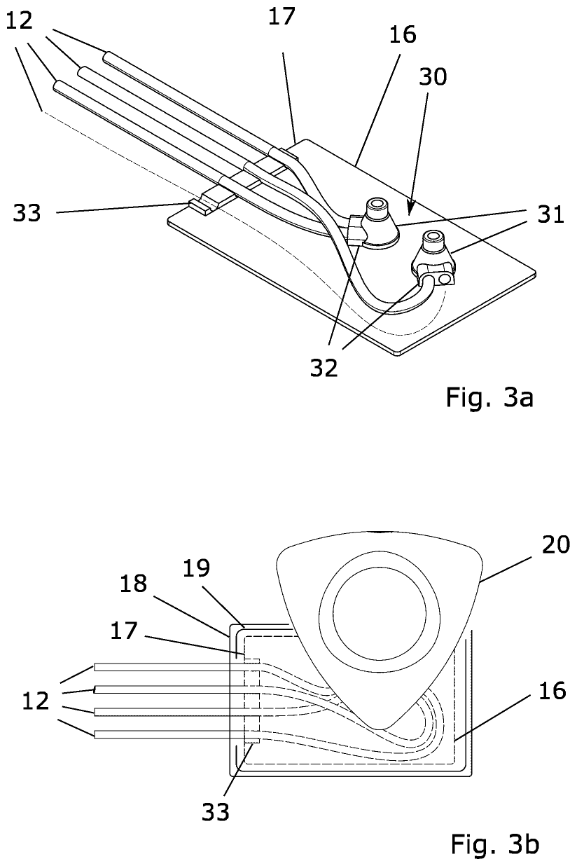

FIG. 3a a first connecting means;

FIG. 3b the first connecting means in a receptacle of the functional unit;

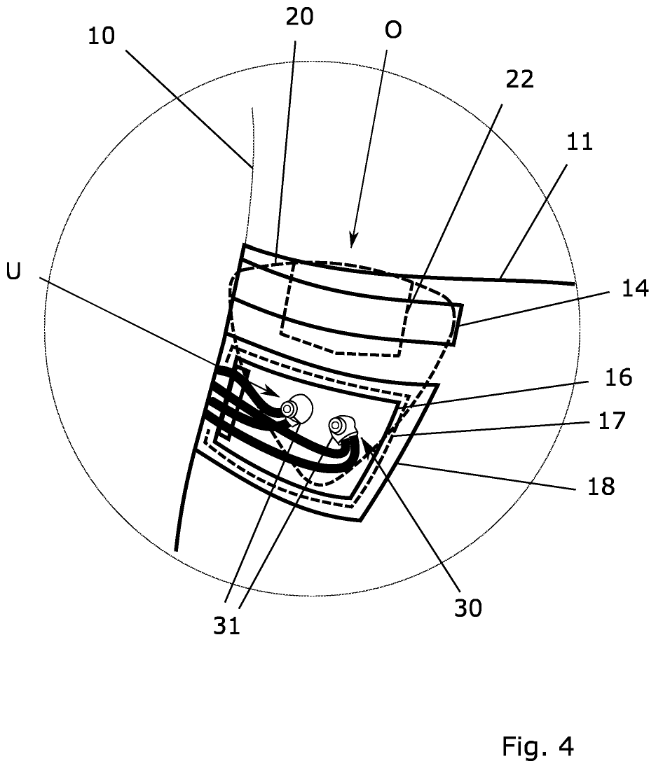

FIG. 4a first fastening means and the first connecting means arranged on the functional unit;

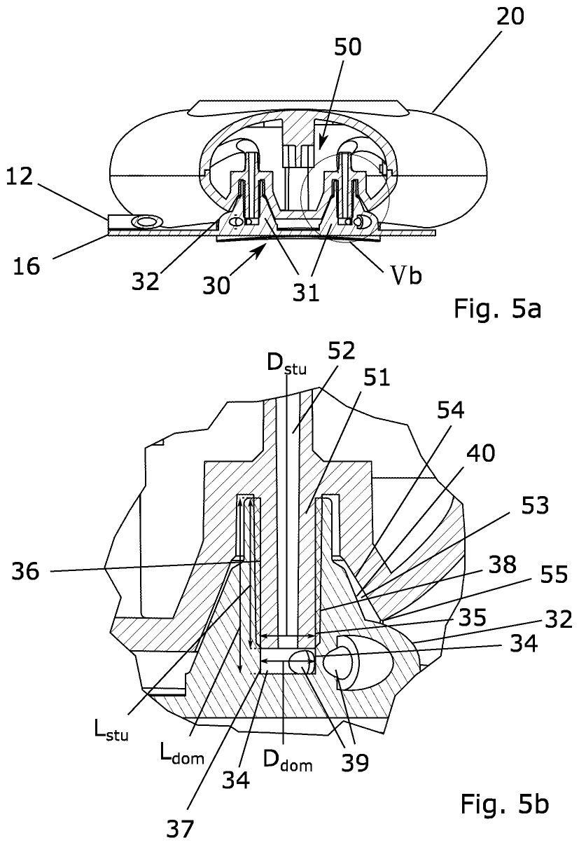

FIG. 5a a partial cross-sectional view of a pump fastened to the functional unit;

FIG. 5b an enlarged view of the area marked ‘Vb’ in FIG. 5a;

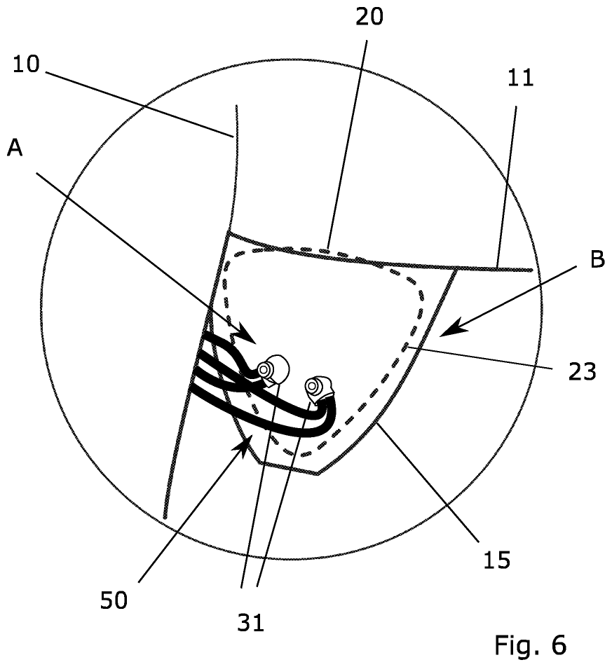

FIG. 6 an alternative design of the first and second fastening means;

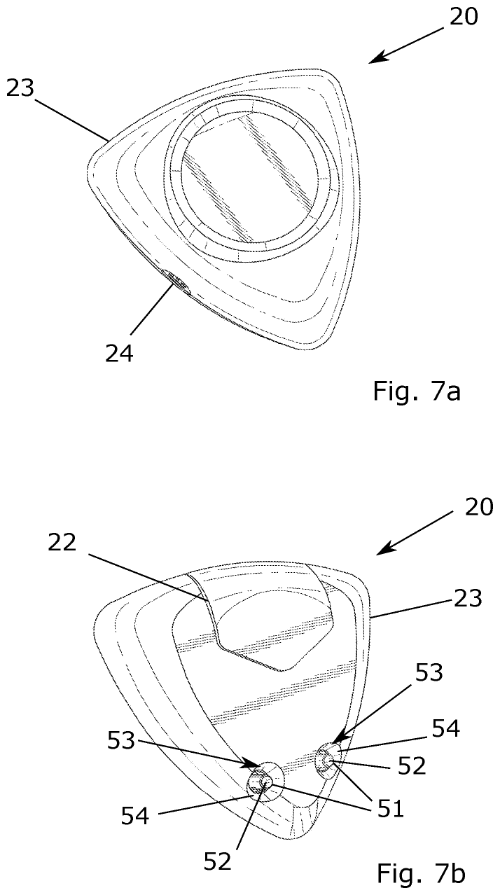

FIG. 7a a perspective view of the pump from the front;

FIG. 7b a perspective view of the pump from behind;

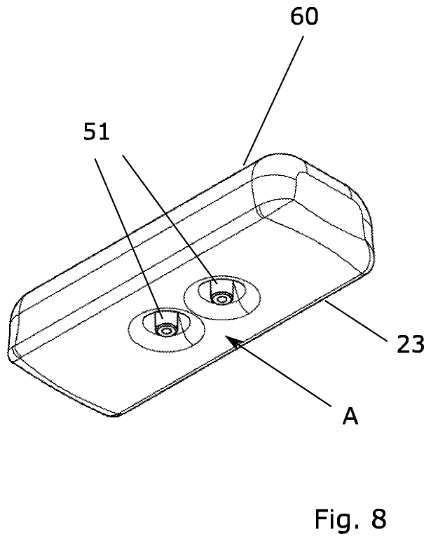

FIG. 8 an alternative design of the pump;

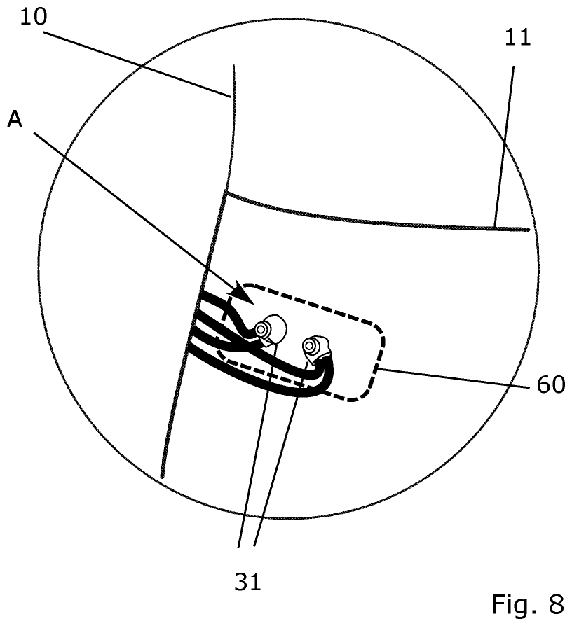

FIG. 9 the alternative design of the pump, arranged on the functional unit.

The functional unit 11 shown in FIG. 1 for a fitness, beauty or wellness device is designed as a pair of trousers which can be worn on a user's body 10. The functional unit 11 has several fluid conduits 12. A pump 20 is fastened to the functional unit 11. Fluid conduits 12 are arranged on functional unit 11 in such a way that they wind around the user's thighs and buttocks. The fluid conduits 12 are connected to the pump 20 so that the fluid conduits 12 can be pressurised with a pressure medium, in particular air. The pressure, which preferably builds up and diminishes in an alternating manner, produces a massage effect on the user's body.

As shown in more detail in FIG. 2, functional unit 11 has a first fastening means 13 and a first connecting means 30. The first fastening means 13 includes a fastening loop 14. The pump 20 has a second fastening means 21 and a second connecting means 50. The second fastening means 21 comprises a fastening hook 22. To fasten the pump 20 to the functional unit 11, the fastening hook 22 is hooked into the fastening loop 14. The fluid conduits 12 must be connected to the pump 20 so that the fluid conduits 12 of the functional unit 11 can be pressurised. This is done by coupling the first connecting means 30 of the functional unit 11 with the second connecting means 50 of the pump 20.

The first fastening means 13 forms an upper support point O on the functional unit 11, and the first connecting means 30 forms a lower support point U on the functional unit 11. When coupling the pump 20 to the functional unit 11, the fastening hook 22 is first hooked into the fastening loop 14 at the upper support point O at an angle α, as shown in dashed lines in FIG. 2. By tilting the pump 20 in the direction of the functional unit 11, the first connecting means 30 is coupled with the second connecting means 50 at the lower support point U. By tilting, the initial angle α between the pump 20 and the functional unit 11 is reduced and the first connecting means 30 is coupled to the second connection device 50 in a fluid-tight manner.

As FIG. 3a shows, the functional unit 11 comprises a support plate 16. The first connecting means 30 is arranged on the support plate 16. In the present case, the first connecting means 30 comprises two identical connection domes 31, but it may also comprise three or more connection domes 31. The connecting domes 31 each have a fluid conduit connection 32. Two fluid conduits 12 each are connected to the fluid conduit connection 32. The fluid conduits 12 extend from the respective fluid conduit connection 32 on the support plate 16 to a fluid conduit edge 17 on the support plate 16 and then extend outside the support plate 16 within the functional unit 11. Movements of the functional unit 11 can exert undesired forces on the fluid conduits 12, which are then transmitted to the respective fluid conduit connection 32 and may impair the function of the fluid conduit connection 32. Therefore, a fluid conduit fastener 33 is provided at the fluid conduit edge 17 of the support plate 16. The fluid conduits 12 can be fastened to the fluid conduit fastener 33 in particular by means of a form-fit connection and/or substance-to-substance bond. This minimizes the transmission of force from the functional unit 11 via the fluid conduits 12 to the respective fluid conduit connection 32.

FIG. 3b shows the support plate 16 in dashed lines. The first connecting means 30 of the functional unit 11 is conductively connected to the second connecting means 50 of the pump 20. The fluid conduits 12 extend from the pump 20 on the support plate 16 to the fluid conduit edge 17 and then extend further outside the support plate 16. The fluid conduits 12 are fixed to the fluid conduit edge 17 by the fluid conduit fastener 33.

As FIG. 3b further shows, the functional unit 11 is provided with a receptacle 18. The support plate 16 is mounted in the receptacle 18 and thus reliably fastened to the functional unit 11. On the receptacle 18, there is a dart 19 which essentially corresponds to the contour of the support plate 16. By means of the dart 19, the support plate 16 is retained securely in the receptacle 18.

The fluid conduits 12 extend in the region of the support plate 16 within the receptacle 18. The dart 19 is therefore interrupted at the fluid conduit edge 17 in order to guide the fluid conduits 12 out of the receptacle 18. The support plate 16 is made of a material which has a higher stiffness than the material which the functional unit 11 is made of, at least in the region of the support plate 16. Furthermore, the receptacle 18 is made of a material which has a higher stiffness than the material which the functional unit 11 is made of, at least in the region of the support plate 16. However, the receptacle 18 is made of a material which has a lower stiffness than the material which the support plate 16 is made of.

FIG. 4 shows how the support plate 16 is positioned within the receptacle 18. Above the receptacle 18, as viewed from the user's body 10, the fastening loop 14 is positioned on the functional unit 11. To fasten the pump 20 to the functional unit 11, the fixing hook 22 is hooked into the fixing loop 14 and thus forms the upper support point O. The two connecting domes 31 form the lower support point U together with two connecting nozzles 51 shown in FIG. 5b.

As FIGS. 5a and 5b show, the connecting domes 31 each have a dome connection passage 34 in its interior, which has an inner circumferential surface 35. The inner circumferential surface 35 comprises a pump connection region 36 and a fluid conduit connection region 37. On the inner circumferential surface 35, an inner lining 38 is provided in the pump connection region 36. To the fluid conduit connection 32, two fluid conduits 12 are connected which lead away from the respective connection domes 31. The inner circumferential surface 35 has two fluid openings 39 within the fluid conduit connection area 37 in the region of the adjacent fluid conduit connection 32, through which the fluid conduits 12 are conductively connected to the dome connection passage 34. The outer faces of the connection domes 31 comprise an outer support surface 40, on which the second connecting means 50 of the pump 20 is supported. The outer support surface 40 has an essentially conical shape.

The second connecting means 50 comprises two connecting nozzles 51, each of which has a nozzle connection passage 52 in its interior. Furthermore, the second connecting means 50 comprises two recesses 53 in each of which a connecting nozzle 51 is arranged. The depth of the recesses 53 corresponds approximately to the length of the respective connecting nozzles 51. The recesses 53 each have an inner support surface 54 which the first connecting means 30 of the functional unit 11 is supported on. The inner support surface 54 has an essentially conical shape.

In order to couple the first connecting means 30 with the second connecting means 50, the connecting nozzles 51 are each inserted into the designated dome connection passages 34 along the inner lining 38. The connecting nozzle 51 has a nozzle diameter Dₛₜᵤ which corresponds approximately to the diameter Doom of the dome connection passage 34, or advantageously is slightly smaller. The inner lining 38 is made of an elastically deformable material, such as silicone. This causes a slight compression of the inner lining 38 when the connecting nozzle 51 is inserted into the dome connection passage 34, thus ensuring a tight connection between the dome connection passage 34 and the nozzle connection passage 52. The length Lₛₜᵤ of the connecting nozzle passage 52 is less than the depth T_{dom} of the dome connection passage 34. At the maximum insertion depth of the connecting nozzle 51 into the dome connection passage 34, the connecting nozzle 51 only contacts the pump connection region 36 of the inner circumferential surface 35 and not the fluid conduit connection region 37 of the inner circumferential surface 35. The fluid openings 39 arranged in the fluid connection region 37 are therefore not blocked by the connecting nozzle 51.

The shape of the recesses 53 of the second connecting means 50 corresponds approximately to the shape of the connecting domes 31. When the connecting nozzle 51 is inserted into the connecting dome 31, the outer support surface 40 of the connecting dome 31 is supported on the inner support surface 54 of the recess 53, and the inner lining 38 is supported on the connecting nozzle 51. This ensures that the pump 20 is retained securely on the functional unit 11.

The fluid conduit connection 32 projects outwards from the connecting domes 31 in relation to the shape of the connecting domes 31. In this region, the inner support surface 54 is shortened in the direction of the functional unit 11 in order to ensure sufficient space for the fluid conduit connection 32. The fluid conduit connection 32 has a rounded shape tapered in the direction of the fluid conduits 12. In the region of the fluid conduit connection 32, the inner support surface 54 is supported on the fluid conduit connection 32 by a support edge 55. This ensures that the pump 20 is retained securely on the functional unit 11 in the region of the fluid conduit connection 32.

As shown in FIG. 6, the first fastening means 13 of the functional unit 11 may be designed as pocket 15, and the second fastening means 21 may be formed by the housing 23. The connecting domes 31 are arranged inside the pocket 15. In order to fasten the pump 20 to the functional unit 11, the pump 20 is inserted into the pocket 15 and connected to the connecting domes 31. The first connecting means 30 is thus operatively connected to the second connecting means 50 at the first support point A.

The pocket 15 may have various designs to facilitate the insertion of the pump 20 into the pocket 15. For instance, the pocket 15 may be made of a combination of velcro and felt that allows the pump 20 to be inserted laterally into the pocket 15.

By placing the pump 20 in the pocket 15, the housing 23 of the pump 20 is supported by the pocket 15 and provides stability.

In addition, a support plate 16, as already described above, may be inserted into the pocket 15. Accordingly, the embodiment shown in FIG. 6 differs from the one shown before in that the first fastening means 13 is designed as pocket 15 instead of the fastening loop 14 and in that the second fastening means 21 is formed by the housing 23 instead of the fastening hook 22.

For a more detailed illustration, FIG. 7a shows the pump 20 in a perspective view from the front. On the inside of pump 20, a battery or accumulator is provided to ensure the mobile operation of the pump 20. In order to be able to charge the accumulator, an electrical connection 24 is arranged in the housing 23. For ergonomic reasons, the electrical connection 24 is located on a side face of the housing 23.

FIG. 7b shows the pump 20 in a perspective view from behind. As described above, two recesses 53 are provided in the housing 23, in each of which a connecting nozzle 51 with a nozzle connection passage 52 is arranged. When coupling the connecting nozzle 51 with the corresponding connecting dome 31, the connecting domes 31 are supported on the inner support surface 54.

The fastening hook 22 tapers in the direction of the connecting nozzles 51 in order to facilitate the insertion of the fastening hook 22 into the corresponding fastening loop 14. For a particularly stable support of the pump 20 on the functional unit 11, the fastening hook 22 has a width that corresponds to the horizontal distance between the connecting nozzles 51.

FIGS. 8 and 9 show a further design of the pump 60. If, for reasons of stability and wearing comfort, the first and second fastening means are not required, the dimensions of the pump 60 may be reduced. The pump 60 still has two connecting nozzles 51. At the first support point A, the pump 60 is plugged onto the connecting domes 31, whereby the first connecting means 30 is operatively coupled to the second connecting means 50 as usual.

With this minimalist design of the pump 60 and the functional unit 11, a first and second fastening means, and thus a second support point B, are completely omitted. Simply plugging the pump 60 onto the connecting domes 31 can provide sufficient support and stability.

In addition, elastic straps may be attached to the functional unit 11, which are pulled over the housing 23 of the pump 60 after connecting the pump 60 to the connecting domes 31, thus providing additional support and stability.

In a further embodiment, the stability may be improved by a velcro strap arranged on the underside of the pump 60, which may be connected to a velcro strap arranged on the functional unit 11.

In addition, stability may be achieved by a snap-in connection of the pump 60 in the connecting domes 31.

The fitness, beauty or wellness device described above is characterised by its ease of use and a secure support of the pump 20 on the functional unit 11. This is mainly due to the three-point connection resulting from the connection of the two connecting domes 31 with the connecting nozzles 51 at the lower support point U on the one hand and the connection of the fastening loop 14 with the fastening hook 22 at the upper support point O on the other hand.

List of reference signs

| | |
|---|---|
| 10 | body |
| 11 | functional unit (trousers) |
| 12 | fluid conduits |
| 13 | first fastening means |
| 14 | fastening loop |
| 15 | pocket |
| 16 | support plate |
| 17 | fluid conduit edge |
| 18 | receptacle |
| 19 | dart |
| 20, 60 | pump |
| 21 | second fastening means |
| 22 | fastening hook |
| 23 | housing |
| 24 | electrical connection |
| 30 | first connecting means |
| 31 | connecting domes |
| 32 | fluid conduit connection |
| 33 | fluid conduit fastener |
| 34 | dome connection passage |
| 35 | inner circumferential surface |
| 36 | pump connection region |
| 37 | fluid conduit connection region |
| 38 | inner lining |
| 39 | fluid opening |
| 40 | outer support surface |
| 50 | second connecting means |
| 51 | connecting nozzle |
| 52 | nozzle connection passage |
| 53 | recess |
| 54 | inner support surface |
| 55 | support edge |
| Dₛₜᵤ | nozzle diameter |
| T_{dom} | depth of the dome connection passage |
| Lₛₜᵤ | length of the connecting nozzle |
| D_{dom} | diametre of the dome connection passage |
| A | first support point |
| B | second support point |
| O | upper support point |
| U | lower support point |
| α | angle |

1. A fitness, beauty or wellness device comprising:
a functional unit (11) wearable on a user's body having a first fastening means (13) forming at least a first support point (A) on the functional unit (11) and a first connecting means (30) forming at least a second support point (B) on the functional unit (11), and
a pump (20) comprising a second fastening means (21) for releasably coupling to the first fastening means (13) and a second connecting means (50) for fluid-tightly coupling to the first connecting means (30);
wherein the pump (20) is retained on the functional unit (11) by coupling the first fastening means (13) to the second fastening means (21) at the first support point (A) and additionally by coupling the first connecting means (30) to the second connecting means (50) at the second support point (B),
wherein at the first support point (A) the pump (20) is retained at an angle (α) to the functional unit (11), and
wherein for coupling the first connecting means (30) and the second connecting means (50) at the second support point (B), the pump (20) is tilted in the direction of the functional unit (11) by reducing the existing angle (α) between the pump (20) and the functional unit (11).

2. Device according to claim 1, characterised by a support plate (16) reinforcing the functional unit (11), wherein preferably the second support point (B) is formed at the support plate (16).

3. Device according to claim 1 or 2, characterised in that the first support point (A) comprises at least one upper support point (O) and in that the second support point (B) comprises at least one lower support point (U) which is located in the vertical direction below the upper support point (O).

4. Device according to claim 1 or 2, characterised in that the first support point (A) comprises at least one lower support point (U) and in that the second support point (B) comprises at least one upper support point (O) which is located in the vertical direction above the lower support point (U).

5. Device according to one of claims 1 to 4, characterised in that the first support point (A) and the second support point (B) are arranged at a distance from one another in the horizontal direction.

6. Device according to one of claims 1 to 5, characterised in that the pump (20) has a housing (23) which is preferably made of plastic.

7. Device according to one of claims 1 to 6, characterised in that the first fastening means (13) has a fastening loop (14) and the second fastening means (21) has a fastening hook (22) preferably arranged at the housing (23), wherein the fastening hook (22) can be detachably fastened to the fastening loop (14).

8. Device according to claim 7, characterised in that the first fastening means (13) or the second fastening means (21) comprises a magnet, a clip or a Velcro fastener.

9. Device according to claim 8, characterised in that the first fastening means (13) is designed as a pocket and the second fastening means (21) is formed by the housing (23).

10. Device according to any one of claims 1 to 9, characterised in that the first connecting means (30) has at least one connecting dome (31) and the second connecting means (50) has at least one connecting nozzle (51), wherein the connecting dome (31) is detachably connected to the connecting nozzle (51).

11. Device according to claim 10, characterised in that the second connecting means (50) has at least one recess (53), wherein the connecting nozzle (51) is arranged in the recess (53).

12. Device according to claim 11, characterised in that the connecting dome (31) has an outer support surface (40) and the recess (53) has an inner support surface (54), wherein the outer support surface (40) is supported on the inner support surface (54) when the connecting dome (31) is arranged in the recess (53), wherein preferably each of the outer support surface (40) and the inner support surface (54) is conical.

13. Device according to any one of claims 10 to 12, characterised in that the connecting dome (31) comprises a dome connection passage (34) having a depth (T_{dom}), wherein, in order to form a fluid conduit connection region (37), the connecting nozzle (51) has a length (Lₛₜᵤ) which is less than the depth (T_{dom}) of the dome connection passage (34).

14. Device according to any one of claims 10 to 13, characterised in that the connecting dome (31) has a dome diameter (D_{dom}) and the connecting nozzle (51) has a nozzle diameter (Dₛₜᵤ), wherein preferably the dome diameter (D_{dom}) corresponds approximately to the nozzle diameter (Dₛₜᵤ) in order to create a force-fit connection between the connecting dome (31) and the connecting nozzle (51).

15. Device according to claim 13 or 14, characterised in that the dome connection passage (34) has an inner circumferential surface (35) which forms a pump connection region (36), wherein preferably the inner circumferential surface (35) is provided with an inner lining (38) along the pump connection region (36), wherein further preferably the inner lining (38) consists of an elastically deformable material, in particular silicone.

16. Device according to one of claims 1 to 15, characterised in that the support plate (16) consists of a deformable material which is preferably elastic.

17. Device according to any one of claims 1 to 16, characterised by a receptacle (18) into which the support plate (16) is inserted, in particular sewn.

18. Pump (20) for a fitness, beauty or wellness device according to any one of claims 1 to 17, characterised by multiple support on the functional unit (11) as a result of the coupling of the first fastening means (13) with the second fastening means (21) at the first support point (A) and, additionally, of the coupling of the first connecting means (30) with the second connecting means (50) at the second support point (B),
wherein at the first support point (A), the pump (20) is retained at an angle (α) relative to the functional unit (11), and
wherein, for coupling the first connecting means (30) and the second connecting means (50) at the second support point (B), the pump (20) is tiltable in the direction of the functional unit (11) by reducing the existing angle (α) between the pump (20) and the functional unit (11).

19. Functional unit (11) for a fitness, beauty or wellness device according to any one of claims 1 to 17, characterised by multiple support on the functional unit (11) as a result of the coupling of the first fastening means (13) with the second fastening means (21) at the first support point (A) and, additionally, of the coupling of the first connecting means (30) with the second connecting means (50) at the second support point (B),
wherein at the first support point (A) the pump (20) is retained at an angle (α) relative to the functional unit (11), and
wherein, for coupling the first connecting means (30) and the second connecting means (50) at the second support point (B), the pump (20) is tiltable in the direction of the functional unit (11) by reducing the existing angle (α) between the pump (20) and the functional unit (11).

20. Method for fastening the pump (20) to the functional unit (11) for a fitness, beauty or wellness device according to any one of claims 1 to 17, comprising the steps:
coupling of the first fastening means (13) with the second fastening means (21) at the first support point (A) at an angle (α);
tilting the pump (20) in the direction of the functional unit (11) for coupling the first connecting means (30) and the second connecting means (50) at the second support point (B) by reducing the existing angle (α) between the pump (20) and the functional unit (11).
